(19) United States
(12) Patent Application Publication
(10) Pub. No.: US 2011/0090440 A1
(43) Pub. Date: Apr. 21, 2011

(54) LIQUID CRYSTAL DEVICE, METHOD OF MANUFACTURING THE SAME, AND ELECTRONIC APPARATUS

(75) Inventor: Takaaki Tanaka, Matsumoto-shi (JP)

(73) Assignee: Seiko Epson Corporation, Tokyo (JP)

(21) Appl. No.: 12/904,324

(22) Filed: Oct. 14, 2010

(30) Foreign Application Priority Data
Oct. 19, 2009 (JP) 2009-240114

(51) Int. Cl. G02F 1/1337

(52) U.S. Cl. 349/123

(57) ABSTRACT

A liquid crystal device includes: a liquid crystal layer being interposed between a pair of substrates; an electrode disposed on surfaces of at least one of the pair of substrates facing the liquid crystal layer; a self-assembled film disposed to cover the electrode on the side of the liquid crystal layer; and an inorganic alignment film disposed between the self-assembled film and the liquid crystal layer.

### BACKGROUND

1. Technical Field

The present invention relates to a liquid crystal device, a method of manufacturing the same, and an electronic apparatus, such as a liquid crystal projector, including the liquid crystal device.

2. Related Art

An example of this kind of liquid crystal device includes a liquid crystal device in which a liquid crystal layer is interposed between inorganic alignment films. In this liquid crystal device, there is a region where a liquid crystal comes into contact with electrodes in the gap portion between the inorganic alignment films. Therefore, charges may move in the interface of the liquid crystal and the electrodes, and thus considerable electric asymmetry appears. Since the electric asymmetry causes a display failure such as flicker or screen burns, various techniques suppressing the electric asymmetry have been suggested.

For example, JP-A-2003-57674 discloses a technique for suppressing the electric asymmetry by covering a pixel electrode having a standard electrode potential sign with a metal having a sign opposite to the standard electrode potential sign. JP-A-2006-330527 discloses a technique for reducing a difference between the work functions of upper and lower electrodes by forming a layer made of the same material as that of a counter electrode on a pixel electrode. JP-A-2007-334113 discloses a technique for providing an electron emission suppressing layer made of a material with a higher electronegativity than the material of electrodes to suppress electron emission from the electrodes.

In the technique disclosed in JP-A-2003-57674, however, the thickness of film and the quality of a film have to be adjusted with high precision to keep the electric balance when a layer made of a different material is formed on the surface of the pixel electrode. As in the technique disclosed in JP-A-2006-330527, electric asymmetry may occur due to the influence of a film forming history or the like, even when the uppermost surface of electrodes is made of the same material. Moreover, it is very difficult to realize reproducibility of a layer suppressing movement of charges precisely and uniformly in a vacuum film forming method as in JP-A-2007-334113. That is, the above-mentioned techniques have the technical problem that the manufacturing of an apparatus becomes highly complicated and it is also difficult to reliably suppress the electric asymmetry.

### SUMMARY

An advantage of some aspects of the invention is that it provides a liquid crystal device, a method of manufacturing the same, and an electronic apparatus including the liquid crystal device capable of easily and reliably preventing charges occurring on the surfaces of electrodes from moving.

According to an aspect of the invention, there is provided a liquid crystal device in which a liquid crystal layer is interposed between a pair of substrates. The liquid crystal device includes: electrodes disposed on surfaces of the pair of substrates facing the liquid crystal layer; self-assembled films disposed to cover the electrodes on the sides of the liquid crystal layer; and inorganic alignment films disposed between the self-assembled films and the liquid crystal layer.

In the liquid crystal device according to the aspect of the invention, the liquid crystal layer is interposed between one pair of substrates. Therefore, by controlling an alignment direction of liquid crystal molecules in the liquid crystal layer, various kinds of gray scales can be displayed. The electrodes applying a voltage to the liquid crystal layer are arranged on the surfaces of the pair of substrates facing the liquid crystal layer. Specifically, for example, each of pixel electrodes is arranged in a predetermined pattern in each pixel on the surface of a TFT array substrate and a counter electrode is formed in a solid shape on the surface of a counter substrate facing the TFT array substrate.

In the liquid crystal device, self-assembled films are disposed on the electrodes arranged on the pair of substrates to cover the electrodes from the side of the liquid crystal layer. Inorganic alignment films made of an inorganic material are disposed between the self-assembled films and the liquid crystal layer. That is, the self-assembled films and the inorganic alignment films exist between the liquid crystal layer and the electrodes arranged on the pair of substrates.

When the above-described self-assembled film is not disposed, charges move between the interfaces of liquid crystal and the electrodes due to the fact that there are regions where the liquid crystal comes into direct contact with the electrodes in the gap portion between the inorganic alignment films. Therefore, a display failure such as flicker or screen burns may be caused due to electric asymmetry.

According to the aspects of the invention, however, since the self-assembled films are disposed to cover the electrodes, the interfaces of the liquid crystal and the electrodes are insulated. Therefore, it is possible to prevent the charges from moving between the interfaces of the liquid crystal and the electrodes. Accordingly, it is possible to prevent the above-mentioned display failure from occurring. Moreover, the thickness of the self-assembled film can be easily made uniform when the self-assembled film is formed. Accordingly, it is also possible to prevent occurrence of a problem caused due to unevenness of the thickness of the self-assembled film.

In the liquid crystal device according to the aspect of the invention, as described above, it is possible to prevent the charges from moving on the surfaces of the electrodes. Accordingly, a high-quality image can be displayed.

In the liquid crystal device according to the aspect of the invention, the self-assembled film may be a mono-molecular film.

With such a configuration, since the self-assembled film is the mono-molecular film, the thickness of the self-assembled film depends on the size of the molecule (in other words, the length). Accordingly, the thickness of the self-assembled film can be made uniform very easily.

In the liquid crystal device according to the aspect of the invention, the self-assembled film may include alkanethiol.

With such a configuration, since the self-assembled film includes alkanethiol, the self-assembled film can be easily formed. Moreover, since the thickness of the self-assembled film can be controlled by the length of a methylene chain, the thickness of the self-assembled film can be made uniform very easily.

In the liquid crystal device according to the aspect of the invention, the self-assembled film may include a material having a methylene chain with a length of 8 or more.

With such a configuration, since the self-assembled film includes a material having a methylene chain with the length of 8 or more, the insulation property of the self-assembled film is very satisfactory. Accordingly, it is possible to effectively prevent the charges from moving between the interfaces of the liquid crystal and the electrodes.

According to the study of the inventor of the invention, when the length of the methylene chain in the self-assembled film is 8 or more, it is proved that the display failure can be greatly reduced compared to a case where the length of the methylene chain is 7 or less.

According to another aspect of the invention, there is provided a method of manufacturing a liquid crystal device in which a liquid crystal layer is interposed between a pair of substrates. The method includes: forming electrodes on surfaces of the pair of substrates facing the liquid crystal layer; forming self-assembled films to cover the electrodes by dipping each of the pair of substrates on which electrodes are formed into a solution including a material used to form the self-assembled films; and forming inorganic alignment films by depositing an inorganic material on the self-assembled films.

In the method of manufacturing the liquid crystal device according to this aspect of the invention, the electrodes such as the pixel electrodes and the counter electrode are formed on one pair of substrates of the liquid crystal device, respectively. These electrodes are formed, for example, by forming conductive films to cover the entire surfaces of the substrates, and then performing patterning by etching or the like. Moreover, a laminated structure formed by a plurality of conductive films and insulation films is generally formed in a lower layer of the electrodes on the substrate.

Subsequently, the pair of substrates in which the electrodes are formed are each dipped into a solution including the material of the self-assembled films. Then, the self-assembled films covering the electrodes are formed on the surfaces (that is, the surfaces of the electrodes) of the substrates. After the self-assembled films are formed, the self-assembled films are cleaned with a solvent or dried with nitrogen.

On the self-assembled films, inorganic materials such as SiO₂ are vacuum-deposited to form the inorganic alignment films. After the inorganic alignment films are formed, the one pair of substrates is bonded to each other by a seal member so that the inorganic alignment films face each other with the liquid crystal layer interposed therebetween.

In the method of manufacturing the liquid crystal device according to the above aspects of the invention, it is possible to form the self-assembled films easily. Accordingly, it is possible to manufacture the liquid crystal device capable of easily and reliably preventing the charges on the surfaces of the electrodes from moving. That is, it is possible to manufacture the liquid crystal device capable of displaying a high-quality image.

Moreover, in the method of manufacturing the liquid crystal device according to the aspect of the invention, the same aspects as the various aspects of the liquid crystal device according to the above-described aspect of the invention can be adopted.

According to still another aspect of the invention, there is provided an electronic apparatus including the above-described liquid crystal device according to the above aspects of the invention (including various aspects).

Since the electronic apparatus according to this aspect of the invention includes the above-described liquid crystal device according to the above aspects of the invention, various electronic apparatuses such as a projection display apparatus, a television, a mobile phone, an electronic pocket book, a word processor, a view finder type or monitor direct view type video tape recorder, a workstation, a video phone, a POS terminal, and a touch panel capable of achieving a high-quality display can be realized.

The operations and other advantages of the invention will become apparent from the description of an embodiment of the invention.

### BRIEF DESCRIPTION OF THE DRAWINGS

The invention will be described with reference to the accompanying drawings, wherein like numbers reference like elements.

FIG. 1 is a plan view illustrating the overall configuration of a liquid crystal device according to an embodiment.

FIG. 2 is a sectional view taken along the line II-II of FIG. 1.

FIG. 3 is a side view conceptually illustrating the configuration of a self-assembled film.

FIG. 4 is a graph illustrating a relationship between an applied voltage and a current between electrodes.

FIG. 5 is a table illustrating a visual level of flicker after 30 minutes of current application.

FIG. 6 is a flowchart illustrating a flow of a method of manufacturing the liquid crystal device according to the embodiment.

FIG. 7 is a plan view illustrating the configuration of a projector as an example of an electronic apparatus to which the liquid crystal device is applied.

### DESCRIPTION OF EXEMPLARY EMBODIMENTS

Hereinafter, an embodiment of the invention will be described with reference to the drawings.

### Liquid Crystal Device

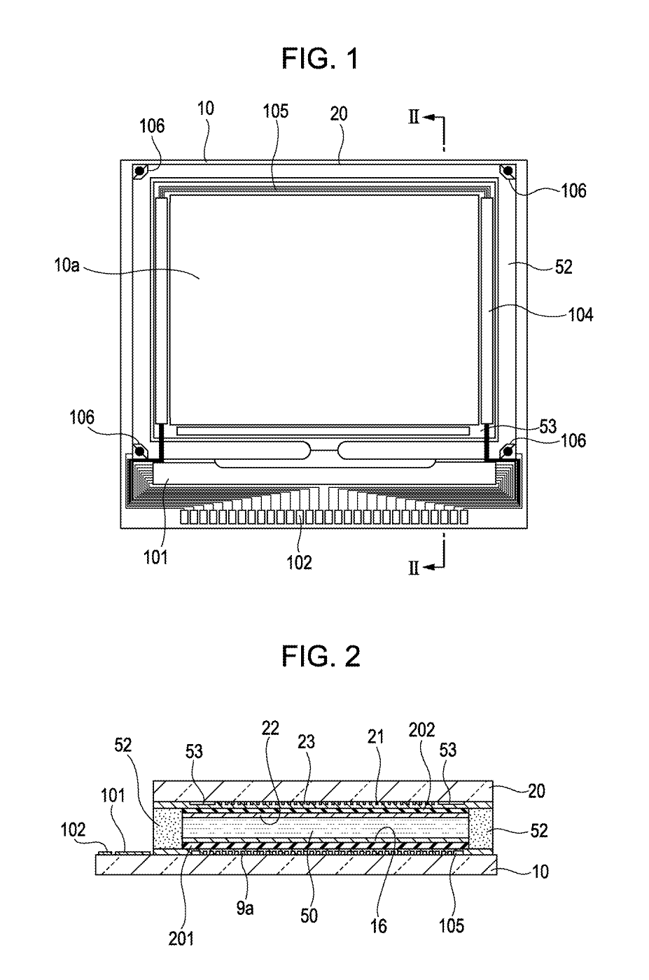

A liquid crystal device according to an embodiment will be first described with reference to FIGS. 1 to 5. In the embodiment described below, a liquid crystal device with a built-in drive circuit of a TFT (Thin Film Transistor) active matrix drive type will be described as an example of the liquid crystal device according to the invention.

The overall configuration of the liquid crystal device according to this embodiment will be described with reference to FIGS. 1 and 2. FIG. 1 is a plan view illustrating the overall configuration of the liquid crystal device according to this embodiment. FIG. 2 is a sectional view taken along the line II-II of FIG. 1.

In FIGS. 1 and 2, a TFT array substrate 10 and a counter substrate 20 which are an example of a “pair of substrates” according to the invention are arranged to be opposite to each other in the liquid crystal device according to this embodiment. The TFT array substrate 10 is, for example, a quartz substrate, a transparent substrate such as a glass substrate, or a silicon substrate. The counter substrate 20 is, for example, a quartz substrate or a transparent substrate such as a glass substrate. The TFT array substrate 10 and the counter substrate 20 interpose a liquid crystal layer 50 therebetween. The liquid crystal layer 50 includes liquid crystal in which one kind or various kinds of nematic liquid crystal are mixed and enters a predetermined alignment state between a pair of alignment films.

The TFT array substrate 10 and the counter substrate 20 are bonded to each other by a seal member 52 disposed in a seal area located around an image display area 10a where a plurality of pixel electrodes is formed.

The seal member 52 which bonds both of the substrates to each other is made of, for example, ultraviolet curing resin or thermosetting resin. The seal member 52 is applied on the TFT array substrate 10 in a manufacturing process, and then is subjected to ultraviolet exposure, heating, or the like. In the seal member 52, a gap material such as fiberglass or glass beads is dispersed to maintain a gap (that is, a gap between the substrates) between the TFT array substrate 10 and the counter substrate 20 at a predetermined value. Moreover, the gap material may be disposed in the image display area 10a or in the peripheral area located around the image display area 10a in addition to or instead of mixtures to the seal member 52.

On the side of the counter substrate 20, a frame light-shielding film 53 having a light shielding characteristic and defining a frame area of the image display area 10a is disposed in parallel in the seal area where the seal member 52 is arranged. Moreover, a part or all of the frame light-shielding film 53 may be arranged as an internal light-shielding film on the side of the TFT array substrate 10.

In the peripheral area, a data line driving circuit 101 and external circuit connection terminals 102 are disposed along one side of the TFT array substrate 10 in an area outside the seal area where the seal member 52 is disposed. Scanning line driving circuits 104 are disposed along two sides adjacent to the one side of the TFT array substrate 10 are covered with the frame light-shielding film 53. Moreover, in order to connect the two scanning line driving circuits 104 disposed on the both sides of the image display area 10a to each other, a plurality of wirings 105 is disposed along the remaining one side of the TFT array substrate 10 and is covered with the frame light-shielding film 53.

Vertical conductive terminals 106 connecting the both substrates to each other by vertical conductive members 107 are disposed in the areas on the TFT array substrate 10 facing four corners of the counter substrate 20. The vertical conductive terminals enable the TFT array substrate 10 and the counter substrate 20 to be electrically conductive with one another.

In FIG. 2, a laminated structure, where pixel switching TFTs serving as driving elements and wirings such as scanning lines and data lines are formed, is formed on the TFT array substrate 10. Although the detailed configuration of the laminated structure is not illustrated in FIG. 2, pixel electrodes 9a made of a transparent material such as ITO (Indium Tin Oxide) are formed in an island shape with a predetermined pattern in every pixel on the laminated structure. The pixel electrode 9a is formed in the image display area 10a on the TFT array substrate 10 to face the counter electrode 21. Moreover, the pixel electrode 9a and the counter electrode 21 are examples of “electrodes” according to the invention.

A self-assembled film 201 is formed on the pixel electrodes 9a in the TFT array substrate 10 to cover the pixel electrodes 9a. The self-assembled film 201 is a film formed of, for example, mono-molecules and has an insulation property. The specific configuration and advantage of the self-assembled film 201 will be described below.

An inorganic alignment film 16 made of an inorganic material is formed on the side of the surface of the TFT array substrate 10 facing the liquid crystal layer 50, that is, on the pixel electrodes 9a and the self-assembled film 201.

A light-shielding film 23 is formed on the surface of the counter substrate 20 facing the TFT array substrate 10. For example, the light-shielding film 23 is formed in a lattice shape in a plan view on the facing surface of the counter substrate 20. A non-opening area is defined in the counter substrate 20 by the light-shielding film 23, and an area defined by the light-shielding film 23 serves as an opening area through which light emitted from, for example, a lamp of a projector or a direct-view backlight passes. Alternatively, the light-shielding film 23 may be formed in a stripe shape and the non-opening area may be defined by the light-shielding film 23 and various constituent elements, such as data lines, disposed on the TFT array substrate 10.

On the light-shielding film 23, the counter electrode 21 made of a transparent material such as ITO is formed to face the plurality of pixel electrodes 9a. On the light-shielding film 23, color filters (not shown in FIG. 2) may be formed in an area including a part of the opening area and the non-opening area in order to display colors in the image display area 10a.

A self-assembled film 202 is formed on the counter electrode 21 in the counter substrate 20 to cover the counter electrode 21 like the TFT array substrate 10. An organic alignment film 22 is formed on the counter electrode 21 and the self-assembled film 202.

On the TFT array substrate 10 shown in FIGS. 1 and 2, not only the above-described driving circuits such as the data line driving circuit 101 and the scanning line driving circuit 104 but also a sampling circuit sampling an image signal on an image signal line and supplying the sampled image signal to the data lines, a pre-charge circuit supplying a pre-charge signal of a predetermined voltage level to the plurality of data lines before the image signal, an inspection circuit inspecting the quality, a defect, or the like of an electrooptical device during a manufacturing process or in shipment, or the like may be formed.

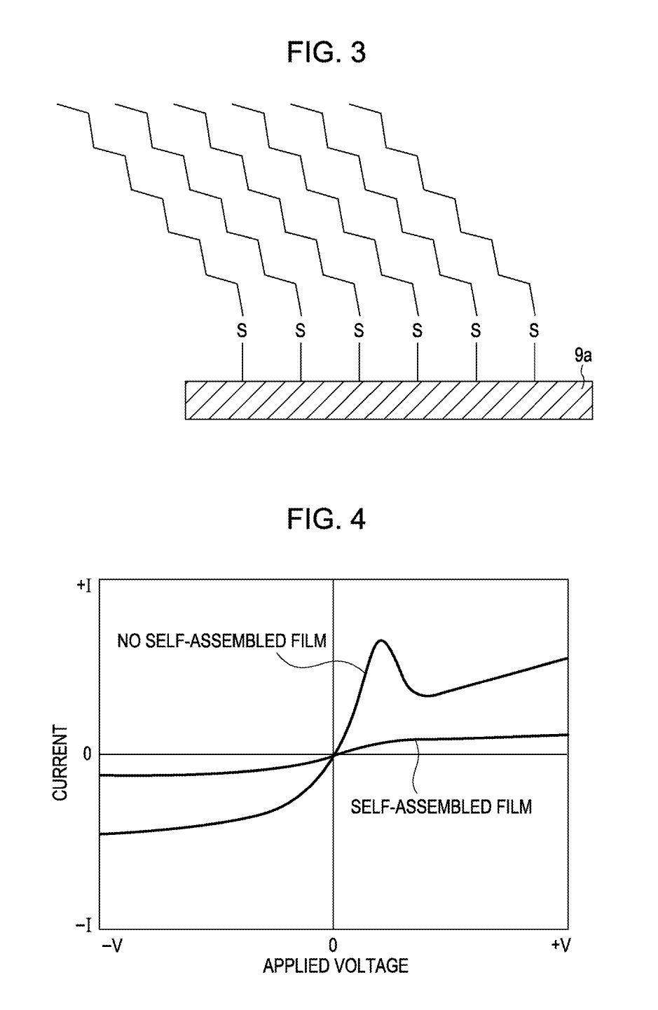

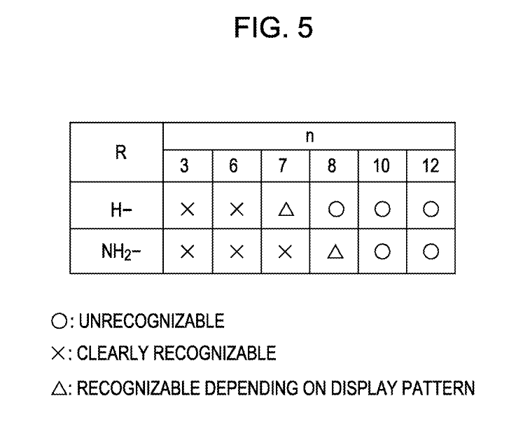

Next, the specific configuration and advantage of the self-assembled film disposed in the liquid crystal device according to this embodiment will be described with reference to FIGS. 3 to 5. FIG. 3 is a side view conceptually illustrating the configuration of the self-assembled film. FIG. 4 is a graph illustrating a relationship between an applied voltage and a current between the electrodes. FIG. 5 is a table illustrating a visual level of flicker after 30 minutes of current application.

In FIG. 3, the self-assembled films 201 and 202 are formed of alkanethiol (R(CH₂)ₙSH). Specific examples of R include H, NH₂, CH₃CO, and CH₃COO.

The self-assembled film 201 is formed by connecting SH of alkanethiols to the pixel electrodes 9a. At this time, the connected alkanethiols are arranged regularly, as shown in FIG. 3. Therefore, the thickness of the formed self-assembled film 201 depends on the length of a methylene chain (that is, (CH₂)ₙ) of alkanethiol. In other words, the thickness of the formed self-assembled film 201 can be controlled by adjusting the length n of the methylene chain. Accordingly, the thickness of the self-assembled film 201 can be very easily made uniform. The same is applied for the self-assembled film 202 (see FIG. 2) on the counter substrate 21.

In FIG. 4, the relationship between a voltage V applied between the pixel electrode 9a and the counter electrode 21 and a current I flowing therein is greatly different depending on whether the self-assembled films 201 and 202 exist.

Specifically, when the self-assembled films 201 and 202 do not exist (that is, when the inorganic alignment films 16 and 22 are directly formed on the pixel electrodes 9a and the counter electrode 21, respectively), a large peak is observed due to injection of charges into the liquid crystal layer. This may cause a display failure such as flicker or screen burns since there are regions where the liquid crystal layer 50 comes into direct contact with the pixel electrodes 9a and the counter electrode 21 in the gap portion between the inorganic alignment films 16 and 22.

In contrast, when the self-assembled films 201 and 202 are disposed, as in this embodiment, the above-mentioned large peak is not observed and the current has also a very small value. This is because the self-assembled films 201 and 202 have an excellent insulation property. When the self-assembled films 201 and 202 have an excellent insulation property, it is possible to prevent charges from moving between the interfaces of the liquid crystal layer 50, the pixel electrodes 9a, and the counter electrode 21. Accordingly, it is possible to prevent the display failure such as flicker or screen burns.

In FIG. 5, according to the study of the inventors, the above-described advantages can be proved by varying the length of the methylene chain of alkanethiol forming the self-assembled films 201 and 202.

For example, when the visual level of flicker after 30 minutes of current application is confirmed in the liquid crystal device, the flicker is weakly recognizable depending on a display pattern in a case where the length of the methylene chain is 7 in alkanethiol where R is H (hydrogen). The flicker is not recognizable irrespective of display pattern when the length of the methylene chain is 8. When the length of the methylene chain is 8 in alkanethiol where R is NH₂ (amino group), the flicker is weakly recognizable depending on a display pattern. When the length of the methylene chain is 9, the flicker is not recognizable irrespective of display pattern.

According to the above result, when the length of the methylene chain is 8 or more and preferably 9 or more, it is possible to prevent the display failure such as flicker or screen burns more reliably. The same is applied to a case where the self-assembled films 201 and 202 are made of a material other than alkanethiol.

In the liquid crystal device according to this embodiment, as described above, it is possible to easily and reliably prevent charges from moving between the surfaces of the electrodes. Accordingly, a high-quality image can be displayed.

In the above-described embodiment, a transmissive liquid crystal device has hitherto been described. However, the same advantages can be obtained by providing the self-assembled films 201 and 202 in a reflective liquid crystal device.

### Method of Manufacturing Liquid Crystal Device

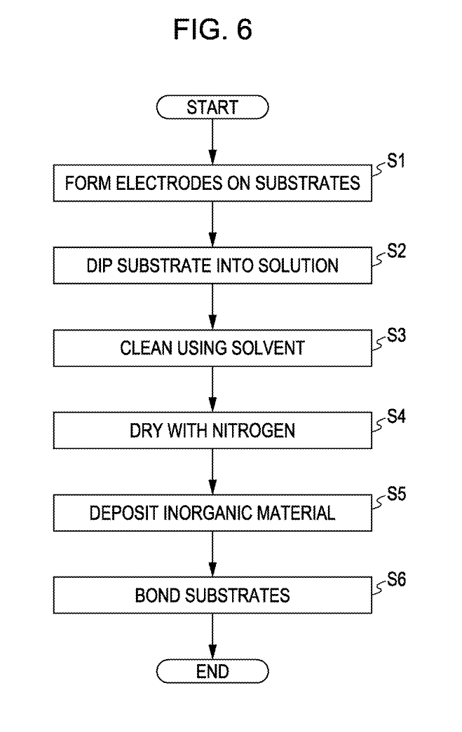

Next, a method of manufacturing the liquid crystal device according to this embodiment will be described with reference to FIG. 6. FIG. 6 is a flowchart illustrating the flow of the method of manufacturing the liquid crystal device according to this embodiment. In FIG. 6, in order to easily make description, only the processes associated with this embodiment among the processes of manufacturing the liquid crystal device will be described and other processes will be omitted.

In FIG. 6, the pixel electrodes 9a and the counter electrode 21 are first formed on the TFT array substrate 10 and the counter substrate 20, respectively, in the method of manufacturing the liquid crystal device according to this embodiment (step S1). The pixel electrodes 9a and the counter electrode 21 are formed, for example, by forming conductive films on the entire surfaces of the TFT array substrate 10 and the counter substrate 20 and then by performing patterning by etching.

Then, the TFT array substrate 10 and the counter substrate 20 are dipped into a solution where alkanethiol with R=CH₃ and n=9 exists in an ethanol solution of 1×10⁻³ mol/l for about 24 hours (step S2). Thus, the self-assembled films 201 and 202 made of alkanethiol are formed on the pixel electrodes 9a and the counter electrode 21, respectively.

After the self-assembled films 201 and 202 are formed, the TFT array substrate 10 and the counter substrate 20 are cleaned using, for example, an ethanol solvent (step S3), and then are dried with nitrogen (step S4).

An inorganic material such as SiO₂ is vacuum-deposited on the self-assembled films 201 and 202 to form the inorganic alignment films 16 and 22 (step S5). After the inorganic alignment films 16 and 22 are formed, a pair of substrates is bonded to each other by the seal member 52 so that the inorganic alignment films 16 and 22 face each other with the liquid crystal layer 50 interposed therebetween.

According to the above-described method of manufacturing the liquid crystal device of this embodiment, the self-assembled films 201 and 202 can be easily formed. Thus, it is possible to manufacture the liquid crystal device capable of preventing the charges occurring in the surfaces of the electrodes from moving more easily and reliably.

### Electronic Apparatus

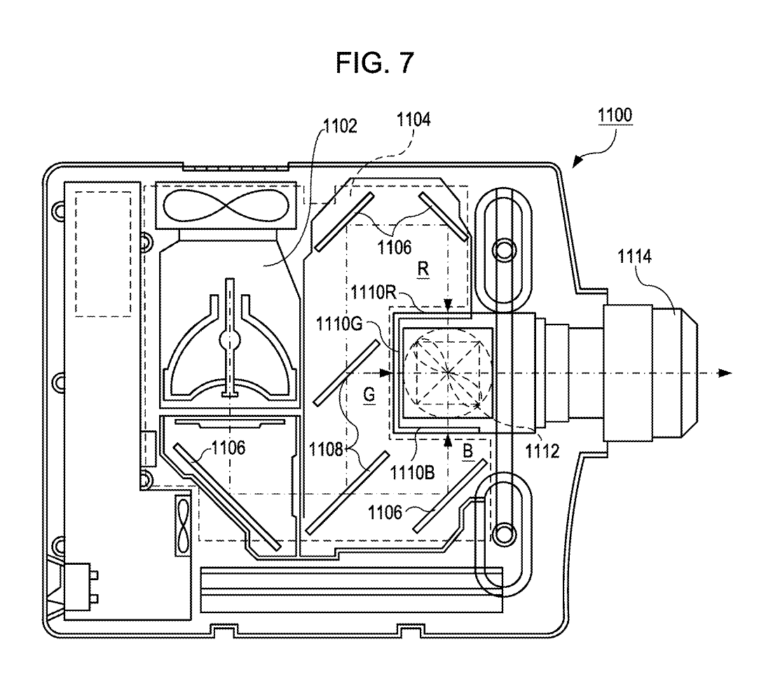

Next, various electronic apparatus to which the above-described liquid crystal device is applied will be described. FIG. 7 is a plan view illustrating an exemplary configuration of a projector. Hereinafter, a projector using the liquid crystal device as a light valve will be described.

As shown in FIG. 7, a lamp unit 1102 formed of a white optical source such as a halogen lamp is installed in a projector 1100. Projecting light emitted from the lamp unit 1102 is divided into the RGB three primary colors by four mirrors 1106 and two dichroic mirrors 1108 disposed in a light guide 1104, and is incident on liquid crystal panels 1110R, 1110B, and 1110G serving as light valves corresponding to the primary colors.

The configuration of the liquid crystal panels 1110R, 1110B, and 1110G is the same as that of the above-described liquid crystal device. The liquid crystal panels 1110R, 1110B, and 1110G are respectively driven by the R, G, and B primary-color signals supplied from an image signal processing circuit. The light modulated by the liquid crystal panels is incident on a dichroic prism 1112 from three directions. In the dichroic prism 1112, R and B light is reflected by 90 degrees, while G light goes straight. Accordingly, respective color images are combined and thus a combined color image is projected on a screen or the like through a projecting lens 1114.

As for the display images formed by the liquid crystal panels 1110R, 1110B, and 1110G, the display image formed by the liquid crystal panel 1110G needs to be mirror-reversed with respect to the display images formed by the liquid crystal panels 1110R and 1110B.

Since the light corresponding to the R, G, and B primary colors is incident on the liquid crystal panels 1110R, 1110B, and 1110G by the dichroic mirrors 1108, it is not necessary to provide a color filter.

Examples of the electronic apparatus include a mobile personal computer, a mobile phone, a liquid crystal TV, a view finder type or monitor direct view-type video tape recorder, a car navigation apparatus, a pager, an electronic pocket book, a calculator, a word processor, a workstation, a video phone, a POS terminal, and an apparatus with a touch panel, as well as the electronic apparatus described with reference to FIG. 7.

The invention is not limited to the above-described embodiment, but may be modified in various forms within the scope without departing from the gist or ideas of the invention understandable from the claims and the specification. Moreover, a modified liquid crystal device, a modified method of manufacturing the same, and an electronic apparatus including the modified liquid crystal device are also included in the technical scope of the invention.

The entire disclosure of Japanese Patent Application No. 2009-240114, filed Oct. 19, 2009 is expressly incorporated by reference herein.

What is claimed is:

1. A liquid crystal device comprising:
a liquid crystal layer being interposed between a pair of substrates;
an electrode disposed on surface of at least one of the pair of substrates facing the liquid crystal layer;
a self-assembled film disposed to cover the electrode on the side of the liquid crystal layer; and
an inorganic alignment film disposed between the self-assembled film and the liquid crystal layer.

2. The liquid crystal device according to claim 1, wherein the self-assembled film is a mono-molecular film.

3. The liquid crystal device according to claim 1, wherein the self-assembled film includes alkanethiol.

4. The liquid crystal device according to claim 1, wherein the self-assembled film includes a material having a methylene chain with a length of 8 or more.

5. An electronic apparatus comprising:
the liquid crystal device according to claim 1.
